(19) United States
(12) Patent Application Publication
(10) Pub. No.: US 2008/0010635 A1
(43) Pub. Date: Jan. 10, 2008

(54) Method, Apparatus, and Program Product for Improving Branch Prediction in a Processor Without Hardware Branch Prediction but Supporting Branch Hint Instruction

(76) Inventors: John Kevin O'Brien, South Salem, NY (US); Kathryn M. O'Brien, South Salem, NY (US)

Correspondence Address: IBM CORP (YA);C/O YEE & ASSOCIATES PC, P.O. BOX 802333, DALLAS, TX, 75380, US

(21) Appl. No.: 11/456,134

(22) Filed: Jul. 7, 2006

(51) Int. Cl. G06F 9/45

(52) U.S. Cl. 717/160

(57) ABSTRACT

A compiler includes a mechanism for improving branch prediction in a processor that supports a branch hint instruction. The compiler receives a sequence of instructions, wherein the sequence of instructions comprises a loop. This loop sequence employs an hbr instruction to avoid the misprediction penalty of the taken branch to the start of the loop on each loop iteration. However, this penalty will be incurred regardless, on exiting the loop. The compiler inserts a compare and select instruction sequence which dynamically changes the input to the hbr instruction thereby avoiding this penalty when leaving the loop.

### BACKGROUND OF THE INVENTION

1. Field of the Invention

The present application relates generally to data processing and, in particular, to compilation of source code to generate executable code. Still more particularly, the present application relates to a compiler method for improving branch prediction in a processor without hardware branch prediction but supporting a branch hint instruction.

2. Description of the Related Art

In cell processor architecture, a synergistic processor element is heavily pipelined and the branch mispredict penalty is high, more specifically 18 cycles. In addition, the hardware's branch prediction policy is simply to assume all branches, including unconditional branches, are not to be taken. In other words, branches are only detected late in the pipeline at a time when there are already multiple fall-through instructions in flight. The goal of such a design is to achieve reduced hardware complexity, faster clock cycles, and increased predictability, which is important for multimedia applications.

Because the performance of taken branches is so much more expensive than the fall-through path, the compiler first attempts to eliminate taken branches by a number of techniques known to those skilled in the art. One effective approach for if-then-else constructs is “if-conversions” via the use of select instructions. Another approach is to determine the likely outcome of branches in a program, either by means of compiler analysis or via user directives, and to perform code reorganization techniques to move cold paths out of the fall-through path.

However, many taken branches cannot practically be eliminated in cases such as function calls, function returns, loop-closing branches, and some unconditional branches. To boost the performance of such predictably taken branches, the synergistic processor element provides for a branch hint instruction, referred to as “Hint for Branch” or hbr. This instruction specifies the location of the branch and the expected target address for a given hinted branch in the execution of code. When a hint for a branch instruction is scheduled sufficiently early, at least 11 cycles before the targeted branch, instructions from the hinted branch target are prefetched from memory and are inserted into the instruction stream immediately after the hinted branch. When the branch is correctly hinted, the branch latency is essentially one cycle; otherwise, the normal branch misprediction penalty applies.

Expected branch outcomes can be measured via branch profiling, estimated statically via sets of heuristics, or provided by the user via expect built-ins or exec freq paradigms. The developer or compiler may then insert a branch hint for branches with a known or statically predicted taken probability higher than a given threshold. Unconditional branches are also good candidates for the branch hint instruction. The indirect form of the branch hint instruction is used before function returns, function calls via pointers, and all other situations that give rise to indirect branches.

For loop-closing branches, the compiler may move the branch hint instructions outside the loop to eliminate the repetitive execution of the hint instruction. A loop is a set of instructions that are repeated while a condition is true. This type of optimization is possible because only one outstanding branch hint is allowed at a time, and that hint remains effective until it is replaced by another one. Because a branch hint instruction indicates the address of its hinted branch by a relative, an 8-bit signed immediate field, a branch hint instruction and its branch instruction, must be within 256 instructions of each other.

Thus, a branch hint instruction can only be moved out from small to medium sized loops. Furthermore, one can only move the hint outside a loop when the loop contains no control flow or no other hinted branches, since at most, one hint can be outstanding at a time. Although loop closing branches are natural candidates for hinting, the branch out of loop will subsequently always incur the branch misprediction penalty.

### SUMMARY

The exemplary embodiments described herein recognize the disadvantages of the prior art and provide a mechanism in a compiler for improving branch prediction in a processor that supports a branch hint instruction. The compiler receives a sequence of instructions, wherein the sequence of instructions comprises a loop. The compiler inserts a register form branch hint instruction that identifies a loop-closing branch statement and its expected target address. The compiler inserts a compare and select instruction sequence that logically selects between a branch taken target address and a fall-through target address. The select instruction provides a selected value which is a branch target address. When executed, the Hint for Branch or hbr will use the selected value to identify the actual target address.

### BRIEF DESCRIPTION OF THE DRAWINGS

The novel features believed characteristic of the invention are set forth in the appended claims. The exemplary embodiments, however, as well as a preferred mode of use, further objectives and advantages thereof, will best be understood by reference to the following detailed description when read in conjunction with the accompanying drawings, wherein:

FIG. 1 is a block diagram of a data processing system in which aspects of the exemplary embodiments may be implemented;

FIG. 2 depicts an exemplary diagram of a Cell BE chip in which aspects of the illustrative embodiments may be implemented;

FIG. 3 is a block diagram illustrating an example of instruction processing in a synergistic processor element in accordance with the exemplary embodiments;

FIGS. 4A-1, 4A-2, 4B-1, 4B-2, 4C-1 and 4C-2 are diagrams illustrating code for a loop in accordance with an illustrative embodiment; and

FIG. 5 is a flowchart illustrating the operation of a compiler for improving branch prediction in a processor that supports a branch hint instruction in accordance with an exemplary embodiment.

### DETAILED DESCRIPTION OF THE ILLUSTRATIVE EMBODIMENT

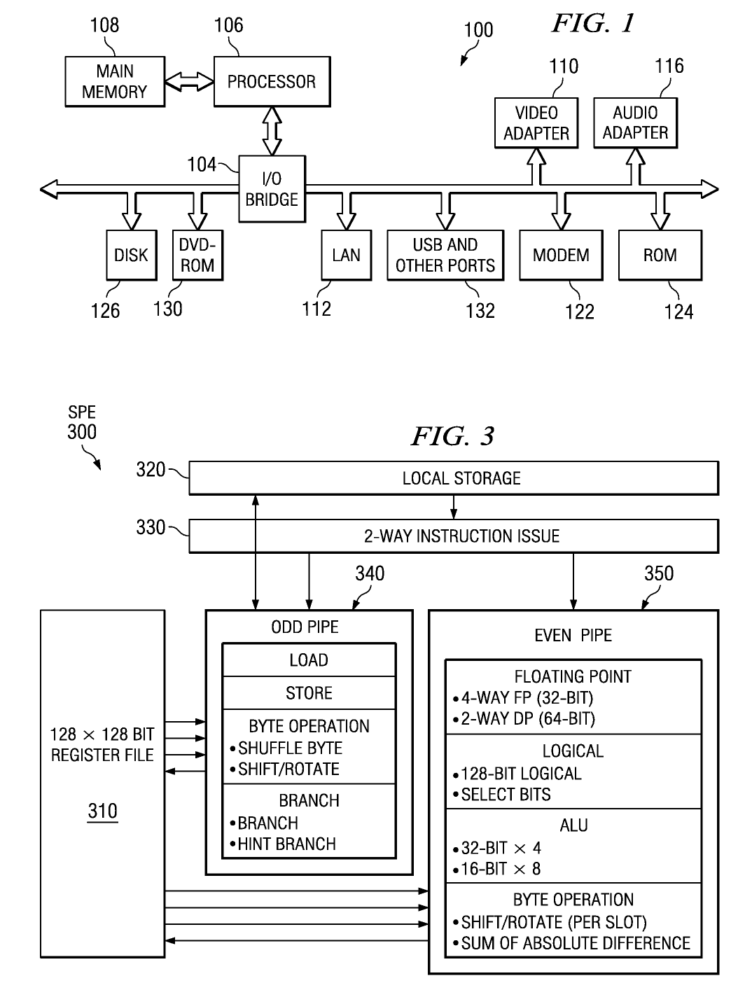

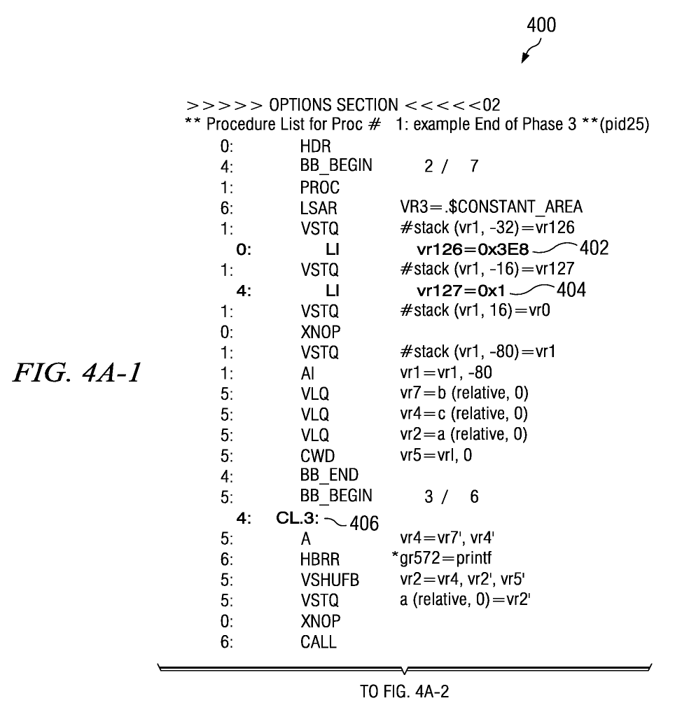

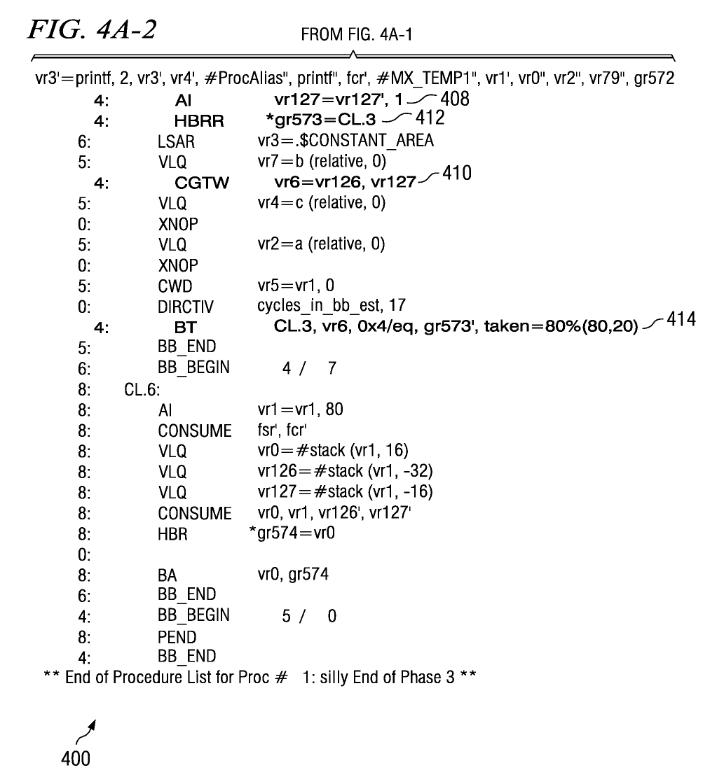

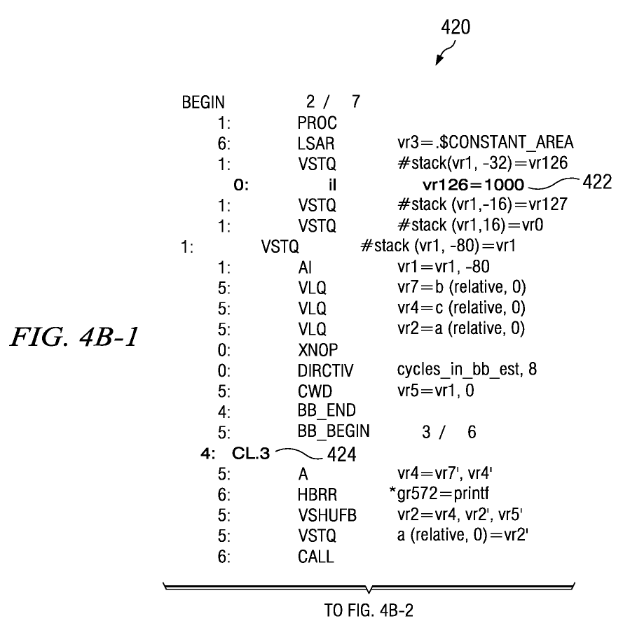

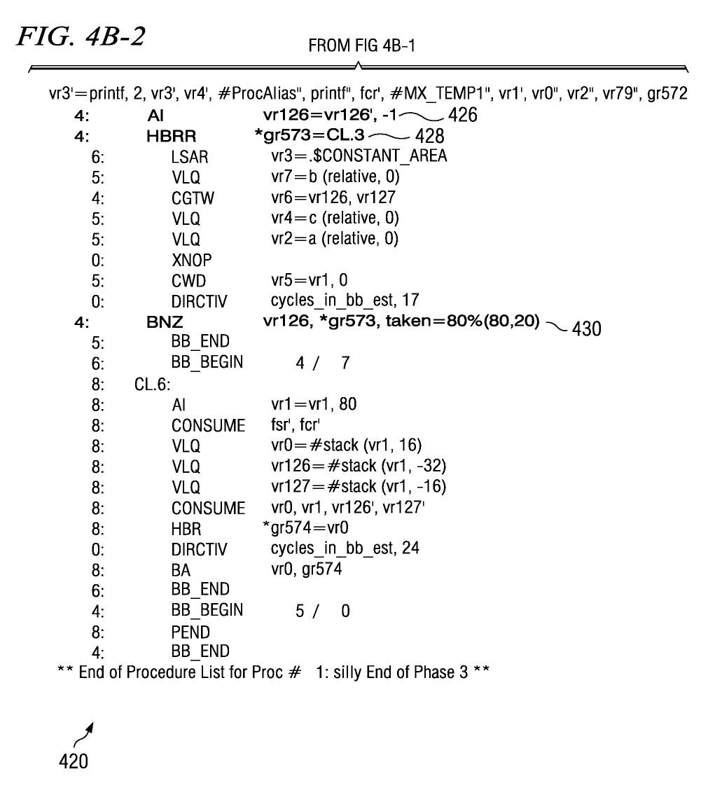

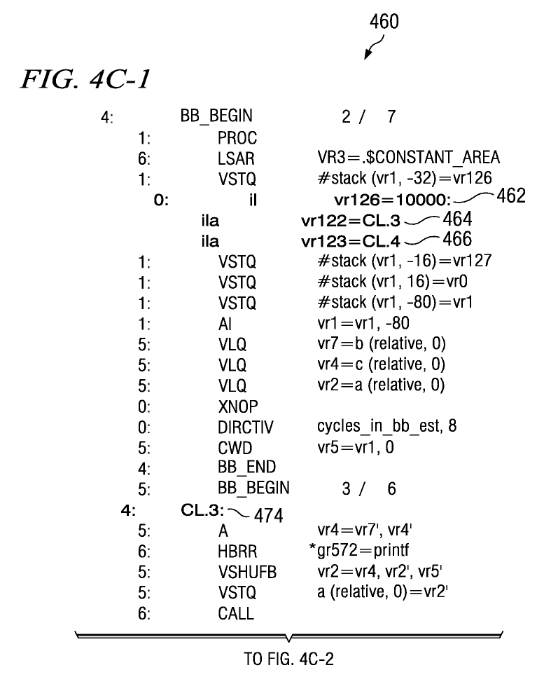

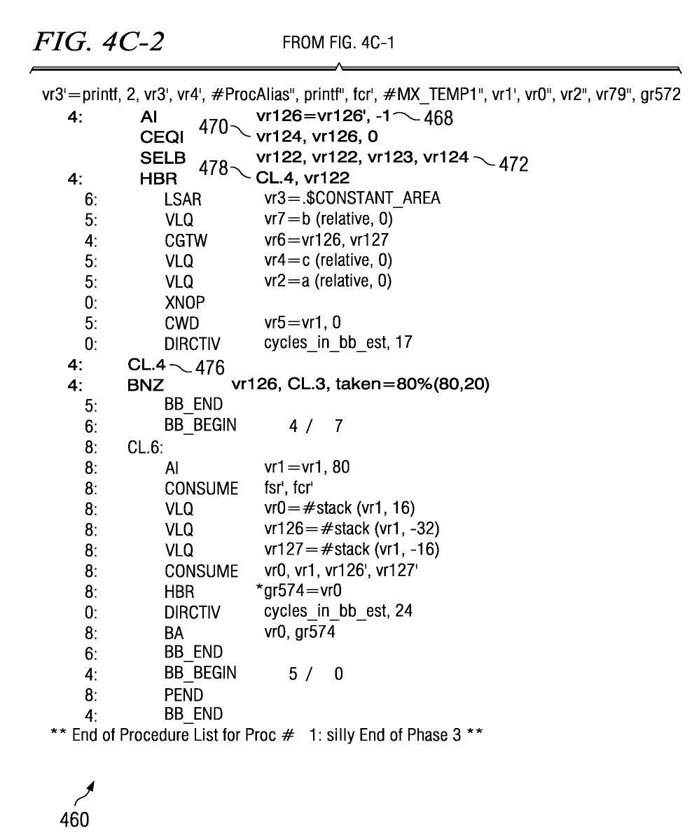

FIGS. 1-5 are provided as exemplary diagrams of data processing environments in which aspects of the exemplary embodiments may be implemented. It should be appreciated that FIGS. 1-5 are only exemplary and are not intended to assert or imply any limitation with regard to the environments in which aspects or embodiments may be implemented. Many modifications to the depicted environments may be made without departing from the spirit and scope of the illustrative embodiments.

With reference now to the figures, FIG. 1 is a block diagram of a data processing system in which aspects of the exemplary embodiments may be implemented. Data processing system 100 is an example of a computer in which code or instructions implementing the processes of the exemplary embodiments may be located. In the depicted example, data processing system 100 employs a hub architecture including an I/O bridge 104. Processor 106 is connected directly to main memory 108, while processor 106 is connected to I/O bridge 104.

In the depicted example, video adapter 110, local area network (LAN) adapter 112, audio adapter 116, read only memory (ROM) 124, hard disk drive (HDD) 126, DVD-ROM drive 130, universal serial bus (USB) ports and other communications ports 132 may be connected to I/O bridge 104. ROM 124 may be, for example, a flash binary input/output system (BIOS). Hard disk drive 126 and DVD-ROM drive 130 may use, for example, an integrated drive electronics (IDE) or serial advanced technology attachment (SATA) interface.

An operating system or specialized program may run on processor 106 and is used to coordinate and provide control of various components within data processing system 100 in FIG. 1. Instructions for the operating system or specialized program or programs are located on storage devices, such as hard disk drive 126, and may be loaded into main memory 108 for execution by processor 106. The processes of the exemplary embodiments may be performed by processor 106 using computer implemented instructions, which may be located in a memory such as, for example, main memory 108, memory 124, or in one or more peripheral devices, such as hard disk drive 126 or DVD-ROM drive 130.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the present invention may be applied to a multiprocessor data processing system.

For example, data processing system 100 may be a general purpose computer, a video game console or other entertainment device, or a server data processing system. The depicted example in FIG. 1 and above-described examples are not meant to imply architectural limitations. For example, data processing system 100 also may be a personal digital assistant (PDA), tablet computer, laptop computer, or telephone device.

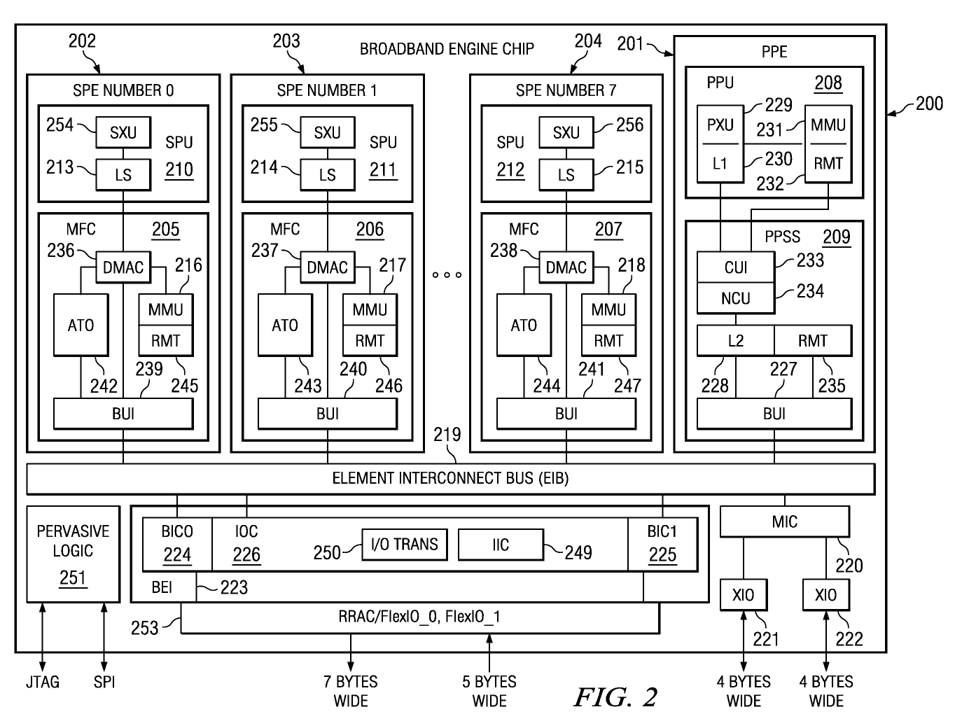

FIG. 2 depicts an exemplary diagram of a Cell Broadband Engine (BE) chip in which aspects of the illustrative embodiments may be implemented. Cell BE chip 200 is a single-chip multiprocessor implementation directed toward distributed processing targeted for media-rich applications such as game consoles, desktop systems, and servers.

Cell BE chip 200 may be logically separated into the following functional components: Power PC® processor element (PPE) 201, synergistic processor units (SPUs) 210, 211, and 212, and memory flow controllers (MFCs) 205, 206, and 207. Although synergistic processor elements (SPEs) 202, 203, and 204 and PPE 201 are shown by example, any type of processor element may be supported. Exemplary Cell BE chip 200 implementation includes one PPE 201 and eight SPEs, although FIG. 2 shows only three SPEs 202, 203, and 204. The SPE of a CELL Processor is a first implementation of a new processor architecture designed to accelerate media and data streaming workloads.

Cell BE chip 200 may be a system-on-a-chip such that each of the elements depicted in FIG. 2 may be provided on a single microprocessor chip. Moreover, Cell BE chip 200 is a heterogeneous processing environment in which each of SPUs 210, 211, and 212 may receive different instructions from each of the other SPUs in the system. Moreover, the instruction set for SPUs 210, 211, and 212 is different from that of Power PC® processor unit (PPU) 208, e.g., PPU 208 may execute Reduced Instruction Set Computer (RISC) based instructions in the Power™ architecture while SPUs 210, 211, and 212 execute vectorized instructions.

Each SPE includes one SPU 210, 211, or 212 with its own local store (LS) area 213, 214, or 215 and a dedicated MFC 205, 206, or 207 that has an associated memory management unit (MMU) 216, 217, or 218 to hold and process memory protection and access permission information. Once again, although SPUs are shown by example, any type of processor unit may be supported. Additionally, Cell BE chip 200 implements element interconnect bus (EIB) 219 and other I/O structures to facilitate on-chip and external data flow.

EIB 219 serves as the primary on-chip bus for PPE 201 and SPEs 202, 203, and 204. In addition, EIB 219 interfaces to other on-chip interface controllers that are dedicated to off-chip accesses. The on-chip interface controllers include the memory interface controller (MIC) 220, which provides two extreme data rate I/O (XIO) memory channels 221 and 222, and Cell BE interface unit (BEI) 223, which provides two high-speed external I/O channels and the internal interrupt control for Cell BE 200. BEI 223 is implemented as bus interface controllers (BICs, labeled BIC0 & BIC1) 224 and 225 and I/O interface controller (IOC) 226. The two high-speed external I/O channels connected to a polarity of Redwood Rambus® Asic Cell (RRAC) interfaces providing the flexible input and output (FlexI0_{—}0 & FlexI0_{—}1) 253 for the Cell BE 200.

Each SPU 210, 211, or 212 has a corresponding LS area 213, 214, or 215 and synergistic execution units (SXU) 254, 255, or 256. Each individual SPU 210, 211, or 212 can execute instructions (including data load and store operations) only from within its associated LS area 213, 214, or 215. For this reason, MFC direct memory access (DMA) operations via SPU's 210, 211, and 212 dedicated MFCs 205, 206, and 207 perform all required data transfers to or from storage elsewhere in a system.

A program running on SPU 210, 211, or 212 only references its own LS area 213, 214, or 215 using a LS address. However, each SPU's LS area 213, 214, or 215 is also assigned a real address (RA) within the overall system's memory map. The RA is the address for which a device will respond. In the Power PC® , an application refers to a memory location (or device) by an effective address (EA), which is then mapped into a virtual address (VA) for the memory location (or device) which is then mapped into the RA. The EA is the address used by an application to reference memory and/or a device. This mapping allows an operating system to allocate more memory than is physically in the system (i.e. the term virtual memory referenced by a VA). A memory map is a listing of all the devices (including memory) in the system and their corresponding RA. The memory map is a map of the real address space which identifies the RA for which a device or memory will respond.

This allows privileged software to map a LS area to the EA of a process to facilitate direct memory access transfers between the LS of one SPU and the LS area of another SPU. PPE 201 may also directly access any SPU's LS area using an EA. In the Power PC® there are three states (problem, privileged, and hypervisor). Privileged software is software that is running in either the privileged or hypervisor states. These states have different access privileges. For example, privileged software may have access to the data structures register for mapping real memory into the EA of an application. Problem state is the state the processor is usually in when running an application and usually is prohibited from accessing system management resources (such as the data structures for mapping real memory).

The MFC DMA data commands always include one LS address and one EA. DMA commands copy memory from one location to another. In this case, an MFC DMA command copies data between an EA and a LS address. The LS address directly addresses LS area 213, 214, or 215 of associated SPU 210, 211, or 212 corresponding to the MFC command queues. Command queues are queues of MFC commands. There is one queue to hold commands from the SPU and one queue to hold commands from the PXU or other devices. However, the EA may be arranged or mapped to access any other memory storage area in the system, including LS areas 213, 214, and 215 of the other SPEs 202, 203, and 204.

Main storage (not shown) is shared by PPU 308, PPE 201, SPEs 202, 203, and 204, and I/O devices (not shown) in a system, such as the system shown in FIG. 2. All information held in main memory is visible to all processors and devices in the system. Programs reference main memory using an EA. Since the MFC proxy command queue, control, and status facilities have RAs and the RA is mapped using an EA, it is possible for a power processor element to initiate DMA operations, using an EA between the main storage and local storage of the associated SPEs 202, 203, and 204.

As an example, when a program running on SPU 210, 211, or 212 needs to access main memory, the SPU program generates and places a DMA command, having an appropriate EA and LS address, into its MFC 205, 206, or 207 command queue. After the command is placed into the queue by the SPU program, MFC 205, 206, or 207 executes the command and transfers the required data between the LS area and main memory. MFC 205, 206, or 207 provides a second proxy command queue for commands generated by other devices, such as PPE 201. The MFC proxy command queue is typically used to store a program in local storage prior to starting the SPU. MFC proxy commands can also be used for context store operations.

The EA address provides the MFC with an address which can be translated into a RA by the MMU. The translation process allows for virtualization of system memory and access protection of memory and devices in the real address space. Since LS areas are mapped into the real address space, the EA can also address all the SPU LS areas.

PPE 201 on Cell BE chip 200 consists of 64-bit PPU 208 and Power PC® storage subsystem (PPSS) 209. PPU 208 contains processor execution unit (PXU) 229, level 1 (L1) cache 230, MMU 231 and replacement management table (RMT) 232. PPSS 209 consists of cacheable interface unit (CIU) 233, non-cacheable unit (NCU) 234, level 2 (L2) cache 228, RMT 235 and bus interface unit (BIU) 227. BIU 227 connects PPSS 209 to EIB 219.

SPU 210, 211, or 212 and MFCs 205, 206, and 207 communicate with each other through unidirectional channels that have capacity. Channels are essentially a FIFO which are accessed using one of 34 SPU instructions; read channel (RDCH), write channel (WRCH), and read channel count (RDCHCNT). The RDCHCNT returns the amount of information in the channel. The capacity is the depth of the FIFO. The channels transport data to and from MFCs 205, 206, and 207, SPUs 210, 211, and 212. BIUs 239, 240, and 241 connect MFCs 205, 206, and 207 to EIB 219.

MFCs 205, 206, and 207 provide two main functions for SPUs 210, 211, and 212. MFCs 205, 206, and 207 move data between SPUs 210, 211, or 212, LS area 213, 214, or 215, and main memory. Additionally, MFCs 205, 206, and 207 provide synchronization facilities between SPUs 210, 211, and 212 and other devices in the system.

MFCs 205, 206, and 207 implementation has four functional units: direct memory access controllers (DMACs) 236, 237, and 238, MMUs 216, 217, and 218, atomic units (ATOs) 242, 243, and 244, RMTs 245, 246, and 247, and BIUs 239, 240, and 241. DMACs 236, 237, and 238 maintain and process MFC command queues (MFC CMDQs) (not shown), which consist of a MFC SPU command queue (MFC SPUQ) and a MFC proxy command queue (MFC PrxyQ). The sixteen-entry, MFC SPUQ handles MFC commands received from the SPU channel interface. The eight-entry, MFC PrxyQ processes MFC commands coming from other devices, such as PPE 201 or SPEs 202, 203, and 204, through memory mapped input and output (MMIO) load and store operations. A typical direct memory access command moves data between LS area 213, 214, or 215 and the main memory. The EA parameter of the MFC DMA command is used to address the main storage, including main memory, local storage, and all devices having a RA. The local storage parameter of the MFC DMA command is used to address the associated local storage.

In a virtual mode, MMUs 216, 217, and 218 provide the address translation and memory protection facilities to handle the EA translation request from DMACs 236, 237, and 238 and send back the translated address. Each SPE's MMU maintains a segment lookaside buffer (SLB) and a translation lookaside buffer (TLB). The SLB translates an EA to a VA and the TLB translates the VA coming out of the SLB to a RA. The EA is used by an application and is usually a 32- or 64-bit address. Different application or multiple copies of an application may use the same EA to reference different storage locations (for example, two copies of an application each using the same EA, will need two different physical memory locations.) To accomplish this, the EA is first translated into a much larger VA space which is common for all applications running under the operating system. The EA to VA translation is performed by the SLB. The VA is then translated into a RA using the TLB, which is a cache of the page table or the mapping table containing the VA to RA mappings. This table is maintained by the operating system.

ATOs 242, 243, and 244 provide the level of data caching necessary for maintaining synchronization with other processing units in the system. Atomic direct memory access commands provide the means for the synergist processor elements to perform synchronization with other units.

The main function of BIUs 239, 240, and 241 is to provide SPEs 202, 203, and 204 with an interface to the EIB. EIB 219 provides a communication path between all of the processor cores on Cell BE chip 200 and the external interface controllers attached to EIB 219.

MIC 220 provides an interface between EIB 219 and one or two of XIOs 221 and 222. Extreme data rate (XDR™) dynamic random access memory (DRAM) is a high-speed, highly serial memory provided by Rambus®. A macro provided by Rambus accesses the extreme data rate dynamic random access memory, referred to in this document as XIOs 221 and 222.

MIC 220 is only a slave on EIB 219. MIC 220 acknowledges commands in its configured address range(s), corresponding to the memory in the supported hubs.

BICs 224 and 225 manage data transfer on and off the chip from EIB 219 to either of two external devices. BICs 224 and 225 may exchange non-coherent traffic with an I/O device, or it can extend EIB 219 to another device, which could even be another Cell BE chip. When used to extend EIB 219, the bus protocol maintains coherency between caches in the Cell BE chip 200 and the caches in the attached external device, which could be another Cell BE chip.

IOC 226 handles commands that originate in an I/O interface device and that are destined for the coherent EIB 219. An I/O interface device may be any device that attaches to an I/O interface such as an I/O bridge chip that attaches multiple I/O devices or another Cell BE chip 200 that is accessed in a non-coherent manner. IOC 226 also intercepts accesses on EIB 219 that are destined to memory-mapped registers that reside in or behind an I/O bridge chip or non-coherent Cell BE chip 200, and routes them to the proper I/O interface. IOC 226 also includes internal interrupt controller (IIC) 249 and I/O address translation unit (I/O Trans) 250.

Pervasive logic 251 is a controller that provides the clock management, test features, and power-on sequence for the Cell BE chip 200. Pervasive logic may provide the thermal management system for the processor. Pervasive logic contains a connection to other devices in the system through a Joint Test Action Group (JTAG) or Serial Peripheral Interface (SPI) interface, which are commonly known in the art.

Although specific examples of how the different components may be implemented have been provided, this is not meant to limit the architecture in which the aspects of the illustrative embodiments may be used. The aspects of the illustrative embodiments may be used with any multi-core processor system.

FIG. 3 is a block diagram illustrating an example of instruction processing in a synergistic processor element in accordance with the exemplary embodiments. SPE 300 stores instructions to be executed in local storage 320. Two-way instruction issue 330 issues instructions to odd pipe 340 and even pipe 350. A pipe in a processor is a set of stages used to process an instruction. Each stage in a pipe may perform a different function. For example, a pipe may have a fetch, decode, execute, and write stages.

In these examples, odd pipe 340 performs load operations, store operations, byte operations, and branch operations on data from register file 310. As shown in the example of FIG. 3, register file 310 includes 128 registers that are 128 bits in length. Byte operations include shuffle byte operations and shift/rotate byte operations. Branch operations include an operation to take a branch and a hint branch operation.

Even pipe 350 performs floating point operations, logical operations, arithmetic logic unit (ALU) operations, and byte operations on data from register file 310 in the depicted examples. In the depicted example, floating point operations include four-way floating point (four 32-bit operations on a 128-bit register) and two-way double precision (DP) floating point (two 64-bit operations on a 128-bit register). Logical operations include 128-bit logical operations and select bits operations. ALU operations include 32-bit operations on four data portions of a 128-bit register and 16-bit operations on eight data portions of a 128-bit register. Byte operations for even pipe 350 include shift/rotate operations and sum of absolute difference operations.

A synergistic processor element is heavily pipelined and its branch mispredict penalty is high. In addition, the hardware's branch prediction policy is simply to assume all branches, including unconditional branches, are not to be taken. In other words, branches are only detected late in the pipeline at a time when there are already multiple fall-through instructions in flight. This design achieves reduced hardware complexity, faster clock cycles, and increased predictability, which is important for multimedia applications.

Although the examples in the illustrative embodiments are describe with respect to a synergistic processor in a heterogeneous multi-processor, the embodiments may be applied to any processor in which hardware branch prediction is not present and which provides a branch hint instruction.

However, many taken branches cannot practically be eliminated in cases such as function calls, function returns, loop-closing branches, and some unconditional branches. To boost the performance of such predictably taken branches, the synergistic processor element provides for a branch hint instruction, referred to as Hint for Branch or hbr. This instruction specifies the location of a branch and its likely target address. In these examples, when the hbr instruction is scheduled sufficiently early, at least 11 cycles before the branch, the synergistic process element prefetches instructions from the hinted branch target from memory and inserts them into the instruction stream immediately after the hinted branch. When the hint is correct, the branch latency is essentially one cycle; otherwise, the normal branch penalty applies.

For certain types of branches, the compiler can statistically predict that they will be taken greater than 50 percent of the time, and inserts hint instructions appropriately. One such category of branches is the branch to the top of a loop, or a loop closing branch. A loop closing branch is also referred to as a loop closing branch statement. In the illustrative embodiments, this type of statement may be used with a sequence of instructions that are executed multiple times using a label at the beginning of the instruction sequence and a branch to that label at the end of the instruction sequence. The manner in which the number of times the branch to the label is executed may be controlled through a loop closing branch statement. The target of the branch (either to the top of the loop, or the exit from the loop) is controlled by a compare instruction, which is referred to as the loop condition.

In accordance with the exemplary embodiment, a compiler identifies loops in a program that may be rewritten as counted loops. The compiler transforms the loop condition and loop closing branch to a form that depends on decrementing a counter to zero. When the value of a counter reaches zero, the loop terminates. In this manner, the compiler can determine by the value of the counter, when the loop is about to terminate.

In these examples, the count value is used in a select instruction to determine the target of a hinted branch as follows: A compare statement or instruction is used to compare a given value to zero and to set a value in a target register depending on the result of the comparison. The compiler then inserts a select instruction that uses the outcome of the compare to select between the fall-through branch target address and the taken target address. This is the selected value mentioned below and is produced by the select instruction. A compare and select instruction sequence contains two instructions in these examples. This sequence is formed by the compare instruction and the select instruction in these illustrative examples.

The compiler then inserts a branch hint instruction that uses the selected value as the target field input. Thus, the branch hint instruction causes prefetching of the taken branch until the count value is zero, at which point the branch hint instruction causes prefetch of the fall-through path. Each time the loop is repeated the count value is decremented by one, in these examples. While the count value is greater than zero, the instructions for the taken branch (beginning at the branch target address) are prefetched for execution.

Turning now to FIGS. 4A-1, 4A-2, 4B-1, 4B-2, 4C-1 and 4C-2, diagrams illustrating code for a loop are depicted in accordance with an illustrative embodiment. Turning first to FIG. 4A-1 and 4A-2, code 400 is an example of intermediate code for a loop for the following source code:

| | |
|---|---|
| 1 | \| example( ) { |
| 2 | \| extern int a,b,c,d; |
| 3 | \| int i; |
| 4 | \| for(i=1;i<1000;i++){ |
| 5 | \| a=b+c; |
| 6 | \| printf(“%d”,a); |
| 7 | \| }; |
| 8 | \| }; |
| 9 | \| |
| 10 | \| |
| 11 | \| |

Lines 402 and 404 in code 400 illustrate instructions to setup for counting the loop from 1 to 1,000.

In this example, register 127 is initialized to 1 and will be incremented in the loop body until the value is equal to the loop upper bound. In this example, the loop bound is 1,000, which is the value stored in register 126. Although registers 126 and 127 are used in these examples, any registers in the processor may be used depending on the particular implementation. The top of the loop in code 400 identified by CL.3 as shown in line 406. Line 408 is used to increment register 127.

Line 410 contains an instruction to compare the contents of register 127 to register 126 with the result being stored in register 6. Line 412 in code 400 is a branch hint instruction hinting the branch in line 414 whose expected target is the label CL.3 in line 406. The address of the expected target is referred to as the expected target address. This address is for the beginning of a loop in these examples. This label marks the top of the loop and will be discussed in more detail below. Line 414 is a branch to the top of the loop in line 406 and occurs depending on the value of register 6. The body of the counted loop in this example is between line 406 and line 414.

Turning now to FIGS. 4B-1 and 4B-2, code 420 illustrates a form of code 400 after code 400 is recast as a counted loop. This figure illustrates an example of a counted loop. The process loops back to the top of the loop a selected number of times before the execution stops looping back to the top of the loop. As illustrated, line 422 contains an instruction used to initialize register 126 to the upper bound for the loop. This value is 1000 in this example. In this example, line 424 shows an instruction the label CL.3, which represents the top of the loop. Line 426 in code 420 is an instruction to decrement register 126, indicating the current upper bound of the loop. In this example, the register is decremented by 1. Line 428 is an instruction showing an indirect form of a branch hint instruction. This instruction shows the label CL.3 in line 424 as the target of the branch instruction shown in line 430.

In line 430, a different form of a branch instruction is illustrated. In this example, line 430 is a branch instruction essentially branching if the value in register 126 is not 0. The branch is to the top of the loop. This type of branch instruction provides an example of recasting the loop in a counted form. This form uses fewer instructions and presents on opportunity for using the value in register 126.

Turning now to FIGS. 4C-1 and 4C-2, code 460, in this example, shows the code sequence from code 420 after recasting as a counted loop and using the register form of the hint for the branch instruction.

More specifically, code 460 illustrates the same code sequence but adds code to dynamically modify the target of the hbr instruction.

The instructions in lines 462, 464, and 466 are used to initialize the counted loop and setup for a compare and select instruction sequence shown lines 468, 470, and 472. Line 468 contains an instructions used to decrement the counted value in the register 126. Line 470 contains the compare instruction, and line 472 contains the select instruction in this example. These instructions compare the decremented loop count and use the result in the select instruction. The selected instruction uses the value to select between a target and a fall though value to put in the result register of the select instruction. In this example, the body of the loop is found between label CL.3 in line 474 and CL.4 in line 476. Line 478 contains a branch hint instruction with a register form. This particular branch hint instruction uses the result value from the SELB instruction in line 474 as the target value of the branch hint instruction.

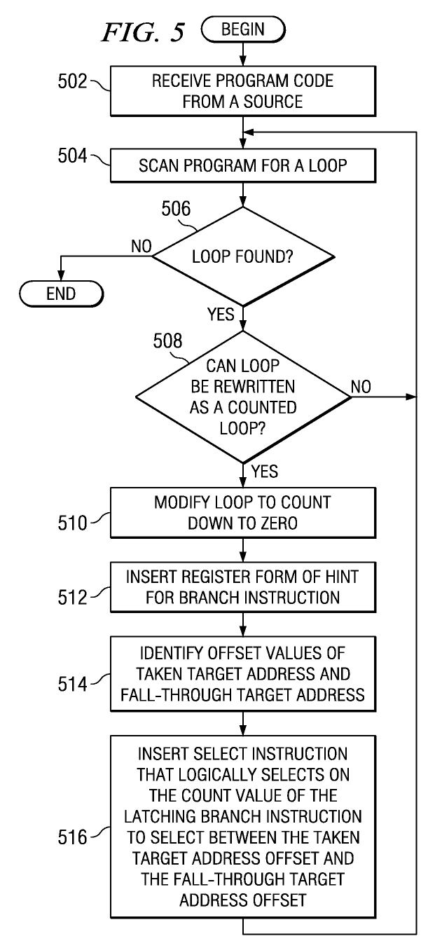

FIG. 5 is a flowchart illustrating the operation of a compiler for improving branch prediction in a processor that supports a branch hint instruction in accordance with an exemplary embodiment of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks.

These computer program instructions may also be stored in a computer-readable memory, transmission medium, or storage medium that can direct a processor or other programmable data processing apparatus to function in a particular manner, such that the instructions stored in the computer-readable memory, transmission medium, or storage medium produce an article of manufacture including instruction means which implement the functions specified in the flowchart block or blocks.

Accordingly, blocks of the flowchart illustration support combinations of means for performing the specified functions, combinations of steps for performing the specified functions and computer usable program code for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions. More particularly, the blocks of the flowchart illustration may be implemented in a compiler used to compile code for execution.

With particular reference to FIG. 5, operation begins and the compiler receives program code (block 502). This program code is received from a source such as a file containing source code. The compiler then scans the source code to identify a loop with a latching branch instruction (step 504). The compiler makes a determination as to whether the loop is found (step 506). If the loop is found, the compiler determines whether the loop can be rewritten as a counted loop (step 508). If the loop can be rewritten as a counted loop, the compiler modifies the loop to count down to zero (block 510), and inserts a register form of the hint for branch instruction (block 512).

The compiler identifies the offset values of the taken target address and the fall-through target address (block 514). Then, the compiler inserts a select instruction that logically selects on the count value of the latching branch instruction, which counts down to zero, to select between the branch taken target address offset and the fall-through target address offset (block 516) with the processes returning to step 504 as described above. A branch taken target address is the address at which execution continues when a branch occurs in the execution of instructions. This address is the instruction located at a label for the branch or is located in a register in these examples. The fall-through target address is the address of the next sequential instruction in the instructions being executed. The result of the select is placed in the register field of the hbr instruction, and thereafter, as a result of this selection, the instructions located at the address contained in the branch target register of the hbr instruction will be fetched.

A branch instruction usually includes a target address. This address is an address at which execution continues if the branch is taken. If the branch is not taken, execution continues with the next sequential instruction in the set of instructions. The outcome of executing a branch instruction results in either the execution of the next sequential instruction or else the instruction located at a label or an address contained in a register. The former is referred to as a fall-through target address with the latter being referred to as a branch-taken target address.

With reference again to step 506, if a loop with a latching branch instruction is not found, the compiler terminates processing the code for these types of loops.

Turning back to step 508, if the loop cannot be rewritten a counted loop, the process returns to step 504 as described above to determine if additional loops with a latching branch instruction are present in the code.

Thus, the exemplary embodiments solve the disadvantages of the prior art by eliminating the branch misprediction penalty incurred on the loop exit branch, whenever a branch hint instruction is used. The branch hint instruction selects the branch taken address during the loop and yet still does not suffer a branch misprediction penalty when exiting the loop. Although the depicted examples are illustrated using a heterogeneous multi-core processor, the embodiments may be applied to any type of processor including a homogenous multi-core processor or even a single core processor. The embodiments are applicable to any processor unit in which loops and branches for loops are present, and which supports a branch hint instruction.

The exemplary embodiments can take the form of an entirely hardware embodiment, an entirely software embodiment or an embodiment containing both hardware and software elements. The exemplary embodiments may be implemented in software, which includes but is not limited to firmware, resident software, microcode, etc.

Furthermore, the exemplary embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the exemplary embodiments has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A computer implemented method for improving branch prediction in a processor that supports a branch hint instruction, the computer implemented method comprising:
receiving, by a compiler, a sequence of instructions, wherein the sequence of instructions comprises a loop;
inserting a compare and select instruction sequence, in the sequence of instructions, that selects between a branch taken target address and a fall-through target address of a next sequential instruction in instructions being executed, wherein a select instruction in the compare and select instruction sequence provides a selected value used to prefetch one of the branch taken target address and the fall-through target address; and
inserting, in the sequence of instructions, a branch hint instruction that identifies a loop-closing branch statement and an expected target address based on the selected value.

2. The computer implemented method of claim 1, further comprising:
recasting the loop as a counted loop counting down to zero.

3. The computer implemented method of claim 2, wherein the loop-closing branch statement branches based on a count value that counts down to zero.

4. The computer implemented method of claim 2, wherein the select instruction selects the branch taken target address if the count value is not zero and wherein the select instruction selects the fall-through target address if the count value is zero.

5. The computer implemented method of claim 1, wherein the branch hint instruction causes the processor to prefetch instructions from memory starting at an address represented by the selected value.

6. The computer implemented method of claim 1, wherein the processor is a synergistic processor element within a cell processor architecture.

7. An apparatus for improving branch prediction in a processor that supports a branch hint instruction, the apparatus comprising:
a processor;
a sequence of instructions to be executed on the processor, wherein the sequence of instructions comprises a loop; and
a compiler, wherein the compiler receives the sequence of instructions, inserts a compare and select instruction sequence, in the sequence of instructions, that selects between a branch taken target address and a fall-through target address of a next sequential instruction in instructions being executed, wherein a select instruction in the compare and select instruction sequence provides a selected value used to prefetch one of the branch taken target address and the fall-through target address, and inserts, in the sequence of instructions, a branch hint instruction that identifies a loop-closing branch statement and an expected target address based on the selected value.

8. The apparatus of claim 7, wherein the compiler recasts the loop as a counted loop counting down to zero.

9. The apparatus of claim 8, wherein the loop-closing branch statement is configure to branch based on a count value that counts down to zero.

10. The apparatus of claim 8, wherein select instruction is configured to select the branch taken target address if the count value is not zero and wherein the select instruction is configured to select the fall-through target address if the count value is zero.

11. The apparatus of claim 7, wherein the branch hint instruction is configured to cause the processor to prefetch instructions from memory starting at an address represented by the selected value.

12. The apparatus of claim 7, wherein the processor is a synergistic processor element within a cell processor architecture.

13. A computer program product for improving branch prediction in a processor that supports a branch hint instruction, the computer program product comprising:
a computer usable medium having computer usable program code embodied therein;
computer usable program code configured to receive, by a compiler, a sequence of instructions, wherein the sequence of instructions comprises a loop;
computer usable program code configured to insert a compare and select instruction sequence, in the sequence of instructions, that selects between a branch taken target address and a fall-through target address of a next sequential instruction in instructions being executed, wherein a select instruction in the compare and select instruction sequence provides a selected value used to prefetch one of the branch taken target address and the fall-through target address; and
computer usable program code configured to insert, in the sequence of instructions, a branch hint instruction that identifies a loop-closing branch statement and an expected target address based on the selected value.

14. The computer program product of claim 13, further comprising:
computer usable program code configured to recast the loop as a counted loop counting down to zero.

15. The computer program product of claim 14, wherein the loop-closing branch statement branches based on a count value that counts down to zero.

16. The computer program product of claim 14, wherein the select instruction is configured to select the branch taken target address if the count value is not zero and wherein the select instruction is configured to select the fall-through target address if the count value is zero.

17. The computer program product of claim 13, wherein the branch hint instruction is configured to cause the processor to prefetch instructions from memory starting at an address represented by the selected value.

18. The computer program product of claim 13, wherein the processor is a synergistic processor element within a cell processor architecture.
